(19) United States
(12) Patent Application Publication
(10) Pub. No.: US 2025/0328060 A1
(43) Pub. Date: Oct. 23, 2025

(54) Image Capturing Device

(71) Applicant: Shenzhen Oceanwing Smart Innovations Technology Co., Ltd., Shenzhen (CN)

(72) Inventors: Miaolin Zhong, Shenzhen (CN); Xin Liu, Shenzhen (CN); Han Lin, Shenzhen (CN); San Chen, Shenzhen (CN)

(21) Appl. No.: 19/255,477

(22) Filed: Jun. 30, 2025

Related U.S. Application Data
(63) Continuation of application No. PCT/CN2023/142424, filed on Dec. 27, 2023.

(30) Foreign Application Priority Data
Dec. 30, 2022 (CN) 202223568865.7

(51) Int. Cl. G03B 17/02; H04N 23/51; H04N 23/695

(52) U.S. Cl. CPC G03B 17/02; H04N 23/51; H04N 23/695

(57) ABSTRACT

Aspects described herein relate to an image capturing device including: a body, a loading shell rotatably connected to the main body, a side of which facing the main body may be provided with a rotation avoidance portion and a side of which away from the main body may be provided with a cambered surface portion, and a drive module connected to the loading shell to drive the loading shell to rotate from a first limit position to a second limit position of the rotation avoidance portion. During rotation, an edge part of the cambered surface portion need not be exposed outside the main body.

### CROSS-REFERENCE TO RELATED APPLICATION

The present application is a continuation of International Patent Application No. PCT/CN2023/142424, filed Dec. 27, 2023, which claims priority to Chinese Patent Application No. 202223568865.7, filed on Dec. 30, 2022, before the China National Intellectual Property Administration, entitled “Image Capturing Device”, which is incorporated herein by reference in its entirety.

### FIELD

The present disclosure relates to intelligent monitoring equipment, such as an image capturing device.

### BACKGROUND

Intelligent monitoring cameras may be widely used for various scenarios such as workshop production, security, protection, warehousing, and logistics, and/or may play a role in safeguarding life and property. Generally, an intelligent monitoring camera might comprise a dome camera that might be equipped with a rotation drive mechanism to expand a capturing range. Since the camera might need to be driven to rotate (e.g., left and right) brackets may be designed generally to hang the dome camera for supporting the dome camera. However, the added brackets can compromise an overall integration of the intelligent monitoring camera.

### SUMMARY

Aspects described herein relate to an image capturing device that may avoid integration issues common to conventional monitoring cameras.

For instance, aspects described herein relate to an image capturing device comprising: a body; a loading shell rotatably connected to the main body, a side of which facing the main body may be provided with a rotation avoidance portion and a side of which away from the main body may be provided with a cambered surface portion; and/or a drive module connected to the loading shell to drive the loading shell to rotate (e.g., from a first limit position to a second limit position of the rotation avoidance portion), during which an edge part of the cambered surface portion may be not exposed outside the main body.

When the image capturing device in the solution operates, the drive module may drive the loading shell (inside which the image capturing execution module may be mounted) to rotate relative to the main body. This might permit the image capturing device to perform multi-angle monitoring. Further, since the loading shell may be provided with the rotation avoidance portion, the loading shell may be configured to reciprocally rotate between the first limit position and the second limit position under the limitation of the rotation avoidance portion, during which the edge part of the cambered surface portion may be not exposed outside the main body, ensuring excellent integration of the loading shell with the main body and enhancing the overall integration of the image capturing device. Moreover, the above structure might save brackets mounted at both sides and simplifies the structure of the image capturing device.

The edge part of the cambered surface portion may include an edge of the rotation avoidance portion. When the cambered surface portion may be a hemispherical structure, the edge part of the cambered surface portion might refer to a rim of the hemispherical structure.

The drive module may include a support shaft, one end of which may be mounted inside the main body, and the other end of which may be connected with the drive module.

The rotation avoidance portion may be an avoidance slot formed on an outer wall of the loading shell, the other end of the support shaft may extend into the avoidance slot, and the drive module drives the loading shell to rotate around the support shaft.

The loading shell may be in the first limit position when the support shaft abuts against a first end of the avoidance slot. The loading shell may be in the second limit position when the support shaft abuts against a second end of the avoidance slot.

The support shaft may be connected to a middle position of the loading shell.

The main body may include a first end cover, of which an end facing the loading shell may be recessed to form an accommodation recess, the loading shell may be rotatably mounted inside the accommodation recess, and, during the rotation of the loading shell from the first limit position to the second limit position, the edge part of the cambered surface portion might not be exposed outside the accommodation recess.

The drive module may include a first rotation drive assembly, a drive main body of the first rotation drive assembly may be mounted at the loading shell, the other end of the support shaft may be fixedly connected to a drive shaft of the first rotation drive assembly, and the first rotation drive assembly may be able to drive the loading shell to perform vertical rotation relative to the main body.

The drive module may include a first rotation drive assembly, a drive main body of the first rotation drive assembly may be mounted at the loading shell, the other end of the support shaft may be fixedly connected to a drive shaft of the first rotation drive assembly, and the first rotation drive assembly may be able to drive the loading shell to perform horizontal rotation or combined horizontal and vertical rotation relative to the main body.

The drive main body of the first rotation drive assembly may be mounted outside the loading shell, and the drive shaft of the first rotation drive assembly may be fixedly connected to the support shaft. Additionally and/or alternatively, the drive main body of the first rotation drive assembly may be mounted inside the loading shell, a wall of the loading shell may be provided with a through hole communicating with the avoidance slot, and/or the drive shaft of the first rotation drive assembly may be fixedly connected to the other end of the support shaft after passing through the through hole and may be in clearance-fit with the through hole.

The first rotation drive assembly may include a first motor mounted inside the loading shell and a waterproof screw, a drive shaft of the first motor passes through the loading shell and may be connected to a side wall of the support shaft, and/or the waterproof screw may be screwed to the drive shaft of the first motor to fixedly connect the support shaft to the first motor.

The loading shell may include a support plate, and the first motor may be disposed on the support plate.

The drive module further may include a second rotation drive assembly disposed on the main body and connected to one end of the support shaft, which may be configured to drive the support shaft and the loading shell to rotate horizontally relative to the main body.

The drive module might further includes a second rotation drive assembly disposed on the main body and connected to one end of the support shaft 31, which may be able to drive the support shaft and the loading shell to perform vertical rotation or combined horizontal and vertical rotation relative to the main body.

The second rotation drive assembly may comprise a second motor, a first transmission wheel, and/or a second transmission wheel, in which the second motor may be mounted inside the main body, a drive shaft of the second motor may be connected to the first transmission wheel, the first transmission wheel may be in transmission fit with the second transmission, and/or the second transmission wheel may be connected to the support shaft.

An adapter board may be mounted inside the main body and provided with a connection cable, the second transmission wheel may be provided with a cable-passing hole, the support shaft may be provided with a cable-passing passage extending along an axis thereof and a cable exiting hole communicating with the cable-passing passage, the cable-passing hole may communicate with a cable-passing passage, the other end of the connection cable may sequentially pass through the cable-passing hole and the cable-passing passage and exits from the cable-exiting hole, so as to be electrically connected to the image capturing execution module in the loading shell.

As another example, an image capturing device may comprise: a main body; a loading shell rotatably connected to the main body and internally provided with a support plate; and/or a drive module including a first rotation drive assembly disposed at the support plate and a support shaft, of which one end may be connected to the main body, and the other end may be connected to the first rotation drive assembly. In that example, the first rotation drive assembly may be able to drive the loading shell to rotate relative to the support shaft and the main body.

In the image capturing device, by mounting the first rotation drive assembly of the drive module at the support plate disposed inside the loading shell and connecting the first rotation drive assembly to the support shaft, the first rotation drive assembly may be capable of driving the loading shell to rotate relative to the support shaft and the main body. This may allow the device to perform monitoring and capturing at different directions and angles. Moreover, the above structure saves brackets mounted at both sides of the image capturing device and simplifies the structure of the image capturing device, which may ensure excellent integration of the loading shell with the main body and enhancing the overall integration of the image capturing device.

The first rotation drive assembly may be able to drive the loading shell to rotate vertically relative to the support shaft and the main body; and/or the drive module may further include a second rotation drive assembly disposed at the main body and connected to the one end of the support shaft. The second rotation drive assembly may be configured to drive the support shaft and the loading shell to rotate horizontally relative to the main body.

The first rotation drive assembly may be located at a middle position in the loading shell.

The loading shell may comprise a front dome shell and/or a rear dome shell assembled to form a mounting cavity, inside which both the first rotation drive assembly and the support plate may be disposed.

The rear dome shell may be provided with a rotation avoidance portion fitting with the support shaft, and during the rotation of the loading shell, an edge part of the rotation avoidance portion may be not exposed outside the main body.

The details of one or more examples of the disclosure are set forth in the following drawings and specification. Other features, objects, and advantages of the disclosure will become apparent from the specification, drawings, and claims.

### BRIEF DESCRIPTION OF THE DRAWINGS

For a better description and illustration of examples and/or examples of the present disclosure, reference may be made to one or more drawings. The additional details or examples used to describe the drawings should not be considered as limit of the scope of any of the disclosed inventions, the presently described examples and/or examples, and the best modes of presently understanding these inventions.

FIG. 1 may be an assembly structure diagram of an image capturing device;

FIG. 2 may be a structure diagram of the image capturing device in FIG. 1 from another perspective;

FIG. 3 may be a structure diagram of an image capturing device with a housing removed;

FIG. 4 may be a structure diagram showing a connection cable;

FIG. 5 may be an exploded structure diagram of an image capturing device;

FIG. 6 may be an exploded structure diagram of a support shaft;

FIG. 7 may be an exploded structure diagram of a loading shell and an image capturing execution module;

FIG. 8 may be a front structure diagram of the image capturing device in FIG. 1;

FIG. 9 may be a structure diagram when a loading shell rotates to a first limit position; and

FIG. 10 may be a structure diagram when a loading shell rotates to a second limit position.

### REFERENCE SIGNS

100: image capturing device; 10: main body; 11: housing; 12: second end cover; 13: first end cover; 131: accommodation recess; 14: first end seal; 15: second end seal; 16: internal seal; 20: image capturing execution module; 21: loading shell; 211: front dome shell; 212: rear dome shell; 2121: avoidance slot; 2121a: first end; 2121b: second end; 213: first seal; 214: cambered surface portion; 215: support plate; 22: camera; 23: camera mainboard; 24: lens waterproof silicone ring; 30: drive module; 31: support shaft; 311: cable-exiting hole; 312: assembly end; 313: drive end; 32: first rotation drive assembly; 321: first motor; 322: waterproof screw; 33: second rotation drive assembly; 331: second motor; 332: first transmission wheel; 333: second transmission wheel; 3331: cable-passing hole; 334: support member; 40: adapter board; 50: connection cable; 60: second seal; 60a: sealing-pressing plate; 60b: fastener.

### DETAILED DESCRIPTION

In order to facilitate understanding of the present disclosure, the present disclosure will be described fully hereinafter with reference to the accompanying drawings. Various illustrative examples of the present disclosure are provided in the drawings. However, the present disclosure may be implemented in many different forms and may be not limited to the examples described herein. It should be understood that these examples are provided for a thorough understanding of the contents of the present disclosure.

In addition, the terms “first” and “second” herein are used for a descriptive purpose only and are not to be construed as indicating or implying the relative importance or implicitly indicating the number of indicated technical features. Thus, features defined with “first” and “second” may explicitly or implicitly include at least one of such features. In the description of the present disclosure, “a plurality of” means at least two, for example, two, three, and so on, unless otherwise explicitly and specifically defined herein.

The terms used in this specification are for the purpose of describing examples and are not intended to limit the present disclosure.

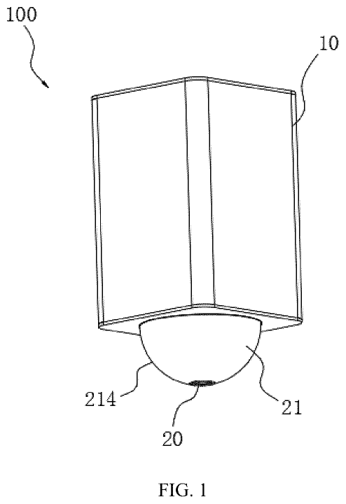

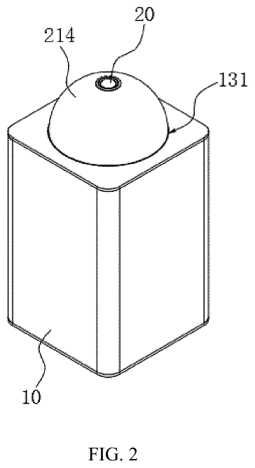

As shown in FIG. 1 and FIG. 2, an image capturing device 100 according to an example of the present disclosure may include a main body 10, an image capturing execution module 20, a loading shell 21, and/or a drive module 30. The main body 10 may be configured to mount and fix the loading shell 21 and the drive module 30, so that the image capturing device 100 might be fixed to an installation object inside a use site. For example, the installation object may include, but may be not limited to, lamp stands, eaves, walls, etc.

A mode for mounting and fixing the main body 10 may include any of screw connection, snap-fit connection, magnetic-attraction connection, hanging connection and the like.

The image capturing execution module 20 may be a direct execution unit for completing image capturing. The image capturing execution module 20 may be mounted inside the loading shell 21 and only a lens part of a camera 22 may be exposed at the loading shell 21.

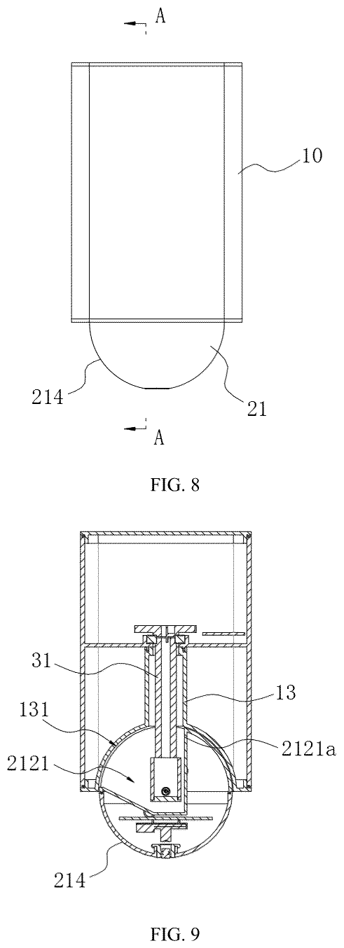

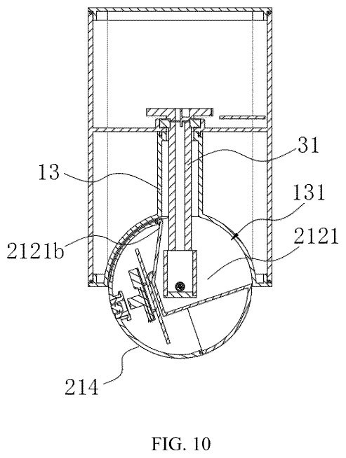

Referring to FIG. 8 to FIG. 10, the loading shell 21 may be rotatably connected to the main body 10. A side of the loading shell 21 facing the main body 10 may be provided with a rotation avoidance portion and a side of the loading shell 21 away from the main body 10 may be provided with a cambered surface portion 214. The drive module 30 may be connected to the loading shell 21 to drive the loading shell 21 to rotate from a first limit position to a second limit position of the rotation avoidance portion, during which an edge part of the cambered surface portion 214 may be not exposed outside the main body 10.

The main body 10 may be provided with an accommodation recess 131. The camera 22 may be mounted at a front dome shell 211 and a rear dome shell 212 may be mounted inside the accommodation recess 131 to achieve an assembly effect where only the front dome shell 211 and the camera 22 are exposed outside the accommodation recess 131, which may ensure a higher integration between the loading shell 21 and the main body 10 and better overall integration of the image capturing device.

The accommodation recess 131 may be a spherical cavity structure having a shape and a size corresponding to those of the rear dome shell 212.

The edge part of the cambered surface portion 214 may include an edge of the rotation avoidance portion. When the cambered surface portion 214 may be a hemispherical structure, the edge part of the cambered surface portion 214 may refer to a rim of the hemispherical structure.

The drive module 30 may include a support shaft 31, one end of which may be mounted inside the main body 10, and the other end of which extends into an avoidance slot 2121. The rotation avoidance portion may refer to the avoidance slot 2121 formed on an outer wall of the loading shell 21. The drive module 30 may be configured to drive the loading shell 21 to rotate around the support shaft 31.

The loading shell 21 may be in the first limit position when the support shaft 31 abuts against a first end 2121a of the avoidance slot 2121 and the loading shell 21 may be in the second limit position when the support shaft 31 abuts against a second end 2121b of the avoidance slot 2121.

The support shaft 31 may be connected to a middle position of the loading shell 21. One end of the support shaft 31 may extend into and may be connected to a middle position of the avoidance slot 2121, which may be more beneficial for precisely controlling travel of the image capturing execution module 20 during bidirectional rotation in a vertical direction and balanced force distribution during rotation.

When the image capturing device 100 in the above technical solution operates, the drive module 30 may drive the loading shell 21 (inside which the image capturing execution module 20 may be mounted) to rotate relative to the main body 10, which may permit the image capturing device 100 to perform multi-angle monitoring. Further, since the loading shell 21 may be provided with the rotation avoidance portion, the loading shell 21 might be capable of reciprocally rotating between the first limit position and the second limit position under the limitation of the rotation avoidance portion, during which the edge part of the cambered surface portion 214 need not be exposed outside the main body 10. That configuration may provide an excellent integration of the loading shell 21 with the main body 10 and enhancing the overall integration of the image capturing device 100. Moreover, the above structure may save brackets mounted at both sides, and may simplify the structure of the image capturing device 100.

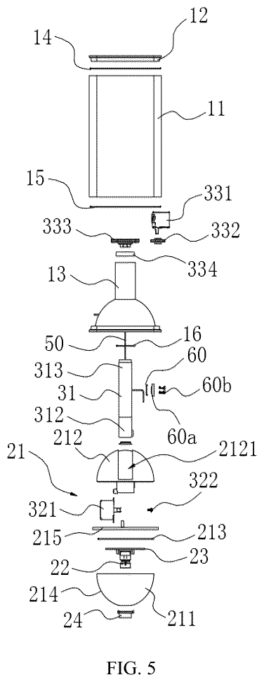

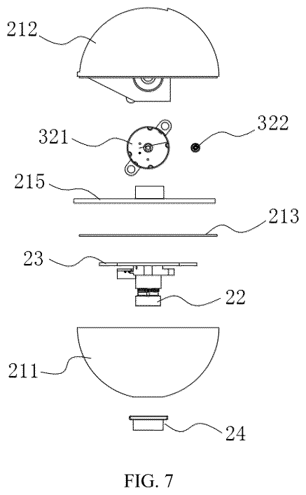

Referring further to FIG. 5 and FIG. 7, the image capturing execution module 20 may include the camera 22 electrically mounted at a camera mainboard 23 and the camera mainboard 23 fixedly mounted at an inner wall of the loading shell 21. The camera mainboard 23 may be configured to control an on/off state, an operation duration, an operating mode and other parameters of the camera 22. The loading shell 21 may enclose the camera mainboard 23 and the camera 22, providing protection for the camera 22.

The loading shell 21 may include a dome shell of which a spherical shape offers a better appearance. The dome shell may include the front dome shell 211, the rear dome shell 212, and/or a first seal 213 among which the front dome shell 211 may be in sealed connection with the rear dome shell 212 through the first seal 213. The first seal 213 may have a function of sealing a joint surface between the front dome shell 211 and the rear dome shell 212, which may enhance an overall sealing performance of the loading shell 21 and may prevent external contaminants such as rainwater and dust from entering the shell to damage the camera 22 and its mainboard 23.

In an example, the first seal 213 may be any of a rubber ring, a silicone ring or other seals.

The image capturing execution module 20 may further include a lens waterproof silicone ring 24 through which the camera 22 may be in sealed connection with the front dome shell 211 to further provide waterproof effects.

The main body 10 may include a first end cover 13 of which an end facing the loading shell 21 may be recessed to form the accommodation recess 131. The loading shell 21 may be rotatably mounted inside the accommodation recess 131, and during the rotation of the loading shell 21 from the first limit position to the second limit position, the edge part of the cambered surface portion 214 need not be exposed outside the accommodation recess 131.

The avoidance slot 2121 may be an elongated recess with a predetermined stroke length. The first end 2121a and second end 2121b in a length direction of the avoidance slot 2121 can physically limit the support shaft 31 separately. That is, the support shaft 31 might abut against the first end 2121a of the avoidance slot 2121 when the drive module 30 drives the loading shell 21 to rotate to the first limit position and the support shaft 31 might abut against the second end 2121b of the avoidance slot 2121 when the drive module 30 drives the loading shell 21 to rotate to the second limit position. Throughout the rotation, an assembly structure of the avoidance slot 2121 of the loading shell 21 and the support shaft 31 may remain hidden within the accommodation recess 131, which may ensure that the edge part of the cambered surface portion 214 of the loading shell 21 need not be exposed outside the main body 10 to avoid exposure.

The edge part of the cambered surface portion 214 of the loading shell 21 may refer to a circular rim of a hemispherical surface when the cambered surface portion 214 may be a hemispherical structure.

The drive module 30 may include a first rotation drive assembly 32 of which a drive main body may be mounted at the loading shell 21 and a drive shaft may be fixedly connected to the other end of the support shaft 31. The first rotation drive assembly 32 may drive the loading shell 21 to rotate vertically relative to the main body 10.

In a mounted and used state, the first rotation drive assembly 32 may be disposed in a horizontally lying manner and can output a rotational drive force in a vertical direction. During operation, since the drive main body of the first rotation drive assembly 32 may be fixedly connected to the loading shell 21 and the drive shaft of the first rotation drive assembly 32 may be fixedly connected to an assembly end 312 of the support shaft 31, the drive main body of the first rotation drive assembly 32 may drive the loading shell 21 to rotate vertically (while the support shaft 31 remains stationary) when the first rotation drive assembly 32 outputs a rotational drive force. For instance, the first rotation drive assembly 32 may drive the image capturing execution module 20 to rotate vertically in an opposite direction to a rotation direction of the drive shaft.

The drive module 30 may include the first rotation drive assembly 32 of which the drive main body may be mounted at the loading shell 21 and the drive shaft may be fixedly connected to the other end of the support shaft 31. The first rotation drive assembly 32 may drive the loading shell 21 to perform horizontal rotation or combined horizontal and vertical rotation relative to the main body 10. This may improve the degree of freedom of rotation for the image capturing device 100 and may enhance multi-angle image capturing capability.

As shown in FIG. 5, the drive main body of the first rotation drive assembly 32 may be mounted inside the loading shell 21. A wall of the loading shell 21 may be provided with a through hole communicating with the avoidance slot 2121. The drive shaft of the first rotation drive assembly 32 may be fixedly connected to the other end (i.e., the assembly end 312) of the support shaft 31 after passing through the through hole and may be in clearance-fit with the through hole to avoid the occurrence of frictional resistance and wear during rotation, ensuring that vertical rotation of the loading shell 21 may be smoother. During this process, the avoidance slot 2121 may guide and limit the assembly end 312 of the support shaft 31, which may ensure that the vertical rotation of the loading shell 21 may be more stable and facilitating improvement in quality and clarity of a captured image.

Additionally and/or alternatively, the drive main body of the first rotation drive assembly 32 may be mounted outside the loading shell 21 and the drive shaft of the first rotation drive assembly 32 may be fixedly connected to the support shaft 31.

For example, the main body 10 may further comprise a housing 11, a second end cover 12, a first end seal 14, a second end seal 15, and/or an internal seal 16. The second end cover 12 may be in sealed connection with a first end opening of the housing 11 through the first end seal 14, a first end of the first end cover 13 may be in sealed connection with a second end opening of the housing 11 through the second end seal 15, and a second end of the first end cover 13 may be in sealed connection with an inner wall of the housing 11 through the internal seal 16.

The housing 11 may be a cylindrical member having openings on opposite ends and a hollow interior. A hollow cavity may provide a space for the support shaft 31 to pass through, which may achieve a hidden mounting effect that the drive module 30 may be entirely mounted inside the main body 10 and the loading shell 21 and may be invisible from the outside.

Mounting and arranging the first end seal 14, the second end seal 15, and/or the internal seal 16 may enhance external and internal waterproof performance of the main body 10 and may improve the safety and reliability when using the image capturing device 100 in outdoor environments.

The first end seal 14, the second end seal 15, and/or the internal seal 16 may comprise, but are not limited to, any of a rubber ring, a silicone ring, or other seals.

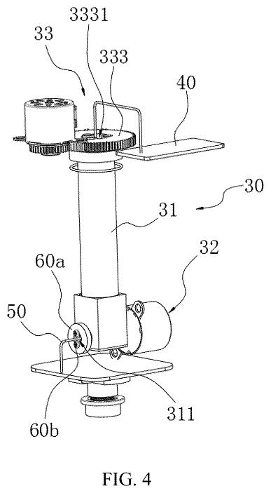

Referring further to FIG. 4, FIG. 5, and FIG. 7, with the image capturing device 100 being in a vertically mounted and used state as the reference, the first rotation drive assembly 32 may be horizontally disposed while the support shaft 31 may be vertically disposed. The first rotation drive assembly 32 may include a first motor 321 mounted inside the loading shell 21 and/or a waterproof screw 322. A drive shaft of the first motor 321 may pass through the through hole of the loading shell 21 and may be connected to a side wall of the support shaft 31. The waterproof screw 322 may be screwed to the drive shaft of the first motor 321 to fixedly connect the support shaft 31 to the first motor 321. The drive shaft of the first motor 321 may be fixedly mounted to the support shaft 31 through the waterproof screw 322, which may effectuate a simple and reliable connection and might also have certain waterproof effects to be conducive to enhancing the reliability for outdoor use.

The first motor 321 may be horizontally disposed and may be fixedly connected to the loading shell 21 to form a single unit, while the drive shaft of the first motor 321 may be fixedly connected to the support shaft 31 through the waterproof screw 322. In this way, when the drive shaft of the first motor 321 rotates, a main body part of the first motor 321 might drive the loading shell 21 (and thus might drive the entire image capturing execution module 20) to rotate vertically in a direction opposite to a direction in which the drive shaft of the first motor 321 rotates. This may achieve requirements of the image capturing execution module 20 for capturing images at different angles with respect to the vertical direction.

The loading shell 21 may further include a support plate 215 at which the first motor 321 may be mounted and to which the first motor 321 may be fixed. Additionally and/or alternatively, the front dome shell 211 may be also fixedly mounted to the support plate 215.

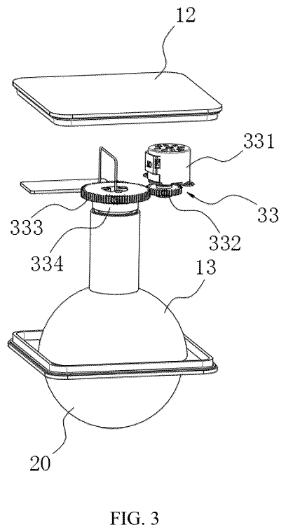

Referring further to FIG. 3 to FIG. 5, based on any of the examples described above, the drive module 30 may further include a second rotation drive assembly 33 disposed at an inner wall of the main body 10 and connected to the one end (i.e., the drive end 313) of the support shaft 31. The second rotation drive assembly 33 might drive the support shaft 31 and the loading shell 21 to rotate horizontally relative to the main body 10, which may meet a requirement of the image capturing execution module 20 for capturing images at different angles within a horizontal range.

Additionally and/or alternatively, the drive module 30 may include the second rotation drive assembly 33 disposed at the main body 10 and connected to the one end of the support shaft 31. The second rotation drive assembly 33 may drive the support shaft 31 and the loading shell 21 to perform vertical rotation or combined horizontal and vertical rotation relative to the main body 10, which may improve the degree of freedom of rotation for the image capturing device 100 and may enhance multi-angle image capturing capability.

The second rotation drive assembly 33 may include a second motor 331 mounted inside the main body 10, a first transmission wheel 332, and/or a second transmission wheel 333. A drive shaft of the second motor 331 may be connected to the first transmission wheel 332, the first transmission wheel 332 may be in transmission fit with the second transmission wheel 333, and/or the second transmission wheel 333 may be connected to the support shaft 31. The second motor 331 may be fixed to a side wall of the housing 11 through screw connection, snap-fit connection, etc., and/or may be vertically disposed.

The first transmission wheel 332 and the second transmission wheel 333 may be arranged in the same horizontal plane and might contact with each other to achieve transmission fit (for example, their axes may be arranged side by side along the vertical direction and may be spaced apart). The second transmission wheel 333 may be connected to the support shaft 31. When the second motor 331 drives the first transmission wheel 332 and the second transmission wheel 333 to rotate horizontally, the second transmission wheel 333 may synchronously drive the support shaft 31 to rotate horizontally, further driving the loading shell 21 to rotate horizontally. The horizontal drive structure may be simple, and has a short transmission path and a better drive effect.

Both the first transmission wheel 332 and the second transmission wheel 333 may comprise gears that have higher transmission precision and efficiency through gear meshing. Further, the first transmission wheel 332 may be a pinion (with a smaller diameter), while the second transmission wheel 333 may be a gear wheel (with a larger diameter). Delivering power from the pinion to the gear wheel may increase a drive torque, which may ensure that the support shaft 31 and the loading shell 21 can rotate more smoothly and reliably.

Additionally and/or alternatively, to improve the stability of the horizontal rotation of the support shaft 31 and reduce wear caused by friction between the support shaft 31 and the housing 11, the second rotation drive assembly 33 may include a support member 334 through which the support shaft 31 may be rotatably disposed at the main body 10. For example, the support member 334 may comprise a bearing.

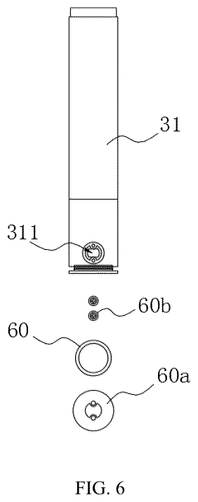

As shown in FIG. 4 and FIG. 6, an adapter board 40 may be mounted inside the main body 10 and may be provided with a connection cable 50. The second transmission wheel 333 may be provided with a cable-passing hole 3331 communicating with a cable-passing passage, and the support shaft 31 may be provided with the cable-passing passage extending along an axis of the support shaft 31 and a cable-exiting hole 311 communicating with the cable-passing passage. The other end of the connection cable 50 may sequentially pass through the cable-passing hole 3331 and the cable-passing passage and might exit from the cable-exiting hole 311 to be electrically connected to the image capturing execution module 20.

The adapter board 40 may be mounted inside the main body 10, and connection cables 50 of other functional boards on the main body may be connected to the adapter board 40. The adapter board 40 may be provided with the connection cable 50. The other end of the connection cable 50 may sequentially pass through the cable-passing hole and the cable-passing passage and exits from the cable-exiting hole 311 of the support shaft 31 to be electrically connected to the image capturing execution module 20. This wiring mode may be simpler and the wiring may be concealed, which may improve the appearance and reliability of the image capturing device. In an example, the other end of the connection cable 50 may be electrically connected to the camera mainboard 23.

Referring further to FIG. 4 to FIG. 6, a cylindrical mounting shaft protruding outward may be disposed at a side of the support shaft 31 opposite to the first motor 321 and may be inserted into an avoidance space of the rear dome shell 212, which may play the role of supporting the support shaft 31 and rotating the loading shell 21 around an axis of the cylindrical mounting shaft. A cylindrical cavity of the cylindrical mounting shaft may form the cable-exiting hole 311. Since the support shaft 31 may have a hollow structure, the connection cable 50 may pass directly through an interior of the main body 10 and the support shaft 31 and might exit from the cable-exiting hole 311 to be connected to the camera mainboard 23. This wiring mode may be simpler and reduces cable winding, which may prolong the service life of the connection cable 50.

To prevent the occurrence of water seepage at the cable-exiting hole 311, a second seal 60 may be provided at an exterior of the cable-exiting hole 311. A sealing-pressing plate 60a may cover an exterior of the second seal 60 and may be connected to the support shaft 31 through a fastener 60b.

The second seal 60 may comprise one or more of: a silicone seal ring, a rubber seal ring or other seal ring. The fastener 60b may comprise a screw directly threaded to the support shaft 31. Such an approach may achieve a simple and reliable connection.

Additionally and/or alternatively, the image capturing device 100 may include the main body 10, the loading shell 21 rotatably connected to the main body 10 and internally provided with the support plate 215, and/or the drive module 30. The drive module 30 may include the first rotation drive assembly 32 disposed at the support plate 215 and the support shaft 31, of which one end may be connected to the main body 10 and the other end may be connected to the first rotation drive assembly 32. The first rotation drive assembly 32 may drive the loading shell 21 to rotate relative to the support shaft 31 and the main body 10.

In the image capturing device 100 of the solution, by mounting the first rotation drive assembly 32 of the drive module 30 at the support plate 215 disposed inside the loading shell 21 and connecting the first rotation drive assembly 32 to the support shaft 31, the first rotation drive assembly 32 may drive the loading shell 21 to rotate relative to the support shaft 31 and the main body 10. This may meet the needs of monitoring and capturing at different directions and angles. Moreover, the above approach may save brackets mounted at both sides of the image capturing device 100 and may simplify the structure of the image capturing device 100, which may ensure excellent integration of the loading shell 21 with the main body 10 and enhancing the overall integration of the image capturing device 100.

The first rotation drive assembly 32 may drive the loading shell 21 to rotate vertically relative to the support shaft 31 and the main body 10. Additionally and/or alternatively, the drive module 30 may further include the second rotation drive assembly 33 disposed at the main body 10 and connected to the one end of the support shaft 31. The second rotation drive assembly 33 can drive the support shaft 31 and the loading shell 21 to rotate horizontally relative to the main body 10. Accordingly, the loading shell 21 may be capable of rotating individually or simultaneously in the horizontal and/or vertical direction, which may meet the needs of the image capturing device 100 for multi-angle, wide-range image capturing, and/or enhancing image capturing performance thereof.

The first rotation drive assembly 32 may be located at the middle portion inside the loading shell 21, which ensures that a mount position of the first rotation drive assembly 32 may be reasonable, may avoid interference occurring during rotation, and may facilitate connection between the first rotation drive assembly 32 and the support shaft 31.

The loading shell 21 may be designed to have a spherical structure, which may improve the appearance while meeting a need of the loading shell 21 for rotational movement at any angle in multiple directions. The loading shell 21 may include the front dome shell 211 and the rear dome shell 212 assembled to form a mounting cavity inside which both the first rotation drive assembly 32 and the support plate 215 may be disposed. Accordingly, the first rotation drive assembly 32 and the support plate 215 may be mounted in a hidden manner, avoiding exposure that may affect the visual appearance of the product while enhancing security capability of the image capturing device 100.

The front dome shell 211 and the rear dome shell 212 may be detachably assembled and fixed through any of screw connection, snap-fit connection, magnetic-attraction connection or other connection modes or any combination thereof.

The rear dome shell 212 may be provided with a rotation avoidance portion fitting with the support shaft 31. During rotation of the loading shell 21, an edge part of the rotation avoidance portion need not be exposed outside the main body, which may ensure the appearance and security capability.

The technical features of the examples can be combined in any way. For conciseness of description, not all possible combinations of the technical features in the examples described above are described. The examples described above represent only several examples of the present disclosure, which are described specifically in detail, but should not be construed thus as limitations on the scope of the present disclosure. It should be noted that several variations and improvements can be made without departing from the spirit of the disclosure.

What is claimed is:

1. An image capturing device comprising:
a body;
a loading shell rotatably connected to the main body, a side of which facing the main body is provided with a rotation avoidance portion and a side of which away from the main body is provided with a cambered surface portion; and
a drive module connected to the loading shell to drive the loading shell to rotate from a first limit position to a second limit position of the rotation avoidance portion, during which an edge part of the cambered surface portion is not exposed outside the main body.

2. The image capturing device of claim 1, wherein one or more of:
the edge part of the cambered surface portion comprises an edge of the rotation avoidance portion, or
when the cambered surface portion is a hemispherical structure, the edge part of the cambered surface portion comprises a rim of the hemispherical structure.

3. The image capturing device of claim 1, wherein the drive module comprises a support shaft, wherein one end of the support shaft is mounted inside the main body, and wherein the other end of the support shaft is connected with the drive module.

4. The image capturing device of claim 3, wherein the rotation avoidance portion comprises an avoidance slot formed on an outer wall of the loading shell, wherein the other end of the support shaft extends into the avoidance slot, and wherein the drive module drives the loading shell to rotate around the support shaft.

5. The image capturing device of claim 4, wherein the loading shell is in the first limit position when the support shaft abuts against a first end of the avoidance slot, and wherein the loading shell is in the second limit position when the support shaft abuts against a second end of the avoidance slot.

6. The image capturing device of claim 3, wherein the support shaft is connected to a middle position of the loading shell.

7. The image capturing device of claim 1, wherein the main body comprises a first end cover, wherein an end of the first end cover facing the loading shell is recessed to form an accommodation recess, wherein the loading shell is rotatably mounted inside the accommodation recess, and wherein, during the rotation of the loading shell from the first limit position to the second limit position, the edge part of the cambered surface portion is not exposed outside the accommodation recess.

8. The image capturing device of claim 3, wherein the drive module comprises a first rotation drive assembly, wherein a drive main body of the first rotation drive assembly is mounted at the loading shell, wherein the other end of the support shaft is fixedly connected to a drive shaft of the first rotation drive assembly, and wherein the first rotation drive assembly is configured to drive the loading shell to perform vertical rotation relative to the main body.

9. The image capturing device of claim 3, wherein the drive module comprises a first rotation drive assembly, wherein a drive main body of the first rotation drive assembly is mounted at the loading shell, wherein the other end of the support shaft is fixedly connected to a drive shaft of the first rotation drive assembly, and wherein the first rotation drive assembly is configured to drive the loading shell to perform horizontal rotation or combined horizontal and vertical rotation relative to the main body.

10. The image capturing device of claim 8, wherein one or more of:
the drive main body of the first rotation drive assembly is mounted outside the loading shell and the drive shaft of the first rotation drive assembly is fixedly connected to the support shaft; or
the drive main body of the first rotation drive assembly is mounted inside the loading shell, a wall of the loading shell is provided with a through hole communicating with an avoidance slot, the drive shaft of the first rotation drive assembly is fixedly connected to the other end of the support shaft after passing through the through hole and is in clearance-fit with the through hole.

11. The image capturing device of claim 8, wherein the first rotation drive assembly comprises a first motor mounted inside the loading shell and a waterproof screw, wherein a drive shaft of the first motor passes through the loading shell and is connected to a side wall of the support shaft, and wherein the waterproof screw is screwed to the drive shaft of the first motor to fixedly connect the support shaft to the first motor.

12. The image capturing device of claim 11, wherein the loading shell comprises a support plate, and wherein the first motor is disposed on the support plate.

13. The image capturing device of claim 3, wherein the drive module further comprises a second rotation drive assembly disposed on the main body and connected to one end of the support shaft, wherein the drive module is configured to drive the support shaft and the loading shell to rotate horizontally relative to the main body.

14. The image capturing device of claim 3, wherein the drive module further comprises a second rotation drive assembly disposed on the main body and connected to one end of the support shaft, wherein the drive module is configured to drive the support shaft and the loading shell to perform vertical rotation or combined horizontal and vertical rotation relative to the main body.

15. The image capturing device of claim 13, wherein the second rotation drive assembly comprises a second motor, a first transmission wheel, and a second transmission wheel, wherein the second motor is mounted inside the main body, wherein a drive shaft of the second motor is connected to the first transmission wheel, wherein the first transmission wheel is in transmission fit with the second transmission, and wherein the second transmission wheel is connected to the support shaft.

16. The image capturing device of claim 15, wherein an adapter board is mounted inside the main body and is provided with a connection cable, wherein the second transmission wheel is provided with a cable-passing hole, wherein the support shaft is provided with a cable-passing passage extending along an axis thereof and a cable exiting hole communicating with the cable-passing passage, wherein the cable-passing hole communicates with a cable-passing passage, wherein the other end of the connection cable sequentially passes through the cable-passing hole and the cable-passing passage and exits from the cable exiting hole, and wherein the other end of the connection cable is electrically connected to the image capturing execution module in the loading shell.

17. An image capturing device comprising:
a main body;
a loading shell rotatably connected to the main body and internally provided with a support plate; and
a drive module comprising a first rotation drive assembly disposed at the support plate and a support shaft, wherein one end of the support shaft is connected to the main body, wherein the other end of the support shaft is connected to the first rotation drive assembly, and wherein the first rotation drive assembly is configured to drive the loading shell to rotate relative to the support shaft and the main body.

18. The image capturing device of claim 17,
wherein the first rotation drive assembly is configured to drive the loading shell to rotate vertically relative to the support shaft and the main body;
wherein the drive module further comprises a second rotation drive assembly disposed at the main body and connected to the one end of the support shaft; and
wherein the second rotation drive assembly is configured to drive the support shaft and the loading shell to rotate horizontally relative to the main body.

19. The image capturing device of claim 17, wherein the first rotation drive assembly is located at a middle position in the loading shell.

20. The image capturing device of claim 17, wherein:
the loading shell comprises a front dome shell and a rear dome shell assembled to form a mounting cavity;
both the first rotation drive assembly and the support plate are disposed inside the loading shell;
the rear dome shell is provided with a rotation avoidance portion fitting with the support shaft; and
during the rotation of the loading shell, an edge part of the rotation avoidance portion is not exposed outside the main body.
